(19) United States
(12) Patent Application Publication
(10) Pub. No.: US 2025/0102803 A1
(43) Pub. Date: Mar. 27, 2025

(54) IMAGE LIGHT GUIDE WITH INTERFERENCE FILTER

(71) Applicant: Vuzix Corporation, West Henrietta, NY (US)

(72) Inventor: Robert J. Schultz, Victor, NY (US)

(21) Appl. No.: 18/728,875

(22) PCT Filed: Jan. 12, 2023
(86) PCT No.: PCT/US2023/010698

§ 371 Date: Jul. 13, 2024

Related U.S. Application Data
(60) Provisional application No. 63/299,674, filed on Jan. 14, 2022.

(51) Int. Cl. G02B 27/01

(52) U.S. Cl. CPC G02B 27/0172

(57) ABSTRACT

An image light guide system including an image light guide having a first surface and a second surface opposite the first surface, an in-coupling diffractive optic operable to couple image-bearing light beams into the image light guide, an out-coupling diffractive optic operable to direct at least a first portion of the image-bearing light beams from the image light guide toward an eyebox and direct a second portion of the image-bearing light beams from the image light guide away from the eyebox, and an interference filter configured to reflect at least a sub-portion of the second portion of the image-bearing light beams and direct the sub-portion of the second portion of the image-bearing light beams towards the eyebox.

### TECHNICAL FIELD

The present disclosure generally relates to electronic displays and more particularly relates to head-mounted near-eye displays that use image light guides to convey image-bearing light beams to a viewer.

### BACKGROUND

Head-mounted near-eye displays, which can take the binocular form of eyeglasses or the monocular form of suspended eyepieces, can include an image generator and an image light guide for presenting virtual images to a wearer's eyes. The image light guides can be arranged with an in-coupling optic and an out-coupling optic incorporated into a transparent waveguide for conveying the virtual images in an angularly encoded form from an offset position of the image generator to a position aligned with the wearer's eye. The transparent waveguide can also provide an aperture through which the wearer can simultaneously view the real world, particularly in support of augmented reality (AR) applications in which the virtual images are superimposed on the real-world scene.

The image generator can take several forms including back-lit, front-lit, or light generating displays combined with focusing optics for converting spatial information into substantially collimated angularly related beams. Alternatively, the image generator can be arranged as a beam scanning device to angularly direct light from a source of substantially collimated light. The two dimensions of the images can also be separately generated such as by a combination of a linear display with a beam scanning device.

Certain applications of such a transparent waveguide may allow portions of light used to generate a virtual image to “leak” out of the front of the waveguide, e.g., in the direction the wearer is facing while wearing the near-eye display. This forward-leaking light can compromise the security of the image or information being displayed to the wearer as others in the vicinity will be able to see the light emitted from the display. The forward-leaking light also represents an inefficiency in the formation of virtual images using the near-eye display in that light that leaks out of the front of the waveguide is not used to form a virtual image within the wearer's eyes, and thus the virtual images presented may appear less bright than they would otherwise appear.

### SUMMARY

The present disclosure is directed to one or more exemplary embodiments of an image light guide system that increases the overall efficiency and brightness of virtual images formed by a transparent light guide by using a narrow spectrum interference filter that reflects the forward-leaking light back into the image light guide. The present disclosure also provides exemplary systems that mitigate any undesirable effects caused by the presence of such a narrow spectrum interference filter on real-world images.

These and other aspects, objects, features, and advantages of the present disclosure will be more clearly understood and appreciated from the following detailed description of the embodiments and appended claims, and by reference to the accompanying drawing figures. In an exemplary embodiment, the present disclosure provides an image light guide system that includes an image light guide having a first surface and a second surface opposite the first surface, an in-coupling diffractive optic operable to couple image-bearing light beams into the image light guide, an out-coupling diffractive optic operable to direct at least a first portion of the image-bearing light beams from the image light guide toward an eyebox and direct a second portion of the image-bearing light beams from the image light guide away from the eyebox, and an interference filter configured to reflect at least a sub-portion of the second portion of the image-bearing light beams and direct the sub-portion of the second portion of the image-bearing light beams towards the eyebox.

Where they are used herein, the terms “first”, “second”, and so on, do not necessarily denote any ordinal, sequential, or priority relation, but are simply used to clearly distinguish one element or set of elements from another, unless specified otherwise.

Where used herein, the term “exemplary” is meant to be “an example of,” and is not intended to suggest any preferred or ideal embodiment.

Where they are used herein, the terms “viewer”, “wearer,” “operator”, “observer”, and “user” are equivalent and refer to the person who wears and views images using an augmented reality system.

Where used herein, the term “coupled” is intended to indicate a physical association, connection, relation, or linking, between two or more components, such that the disposition of one component affects the spatial disposition of a component to which it is coupled. For mechanical coupling, two components need not be in direct contact, but can be linked through one or more intermediary components. A component for optical coupling allows light energy to be input to, or output from, an optical apparatus.

Where used herein, the term “eyebox” is intended to define a two-dimensional area or three-dimensional volume within which an eye at any position therein provides one or more virtual images to the retina of the eye.

Where used herein, the term “beam expansion” is intended to mean replication of a beam via multiple encounters with an optical element to provide exit pupil expansion in one or more dimensions. Similarly, as used herein, to “expand” a beam, or a portion of a beam, is intended to mean replication of a beam via multiple encounters with an optical element to provide exit pupil expansion in one or more dimensions.

### BRIEF DESCRIPTION OF THE DRAWING FIGURES

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1 is a top view of an image light guide of a near-eye display system with an exaggerated thickness for showing the propagation of light from an image source along the image light guide to an eyebox within which the virtual image can be viewed.

FIG. 2 is a perspective view of an image light guide of a near-eye display system including an in-coupling diffractive optic, a turning diffractive optic, and out-coupling diffractive optic for managing the propagation of image-bearing light beams.

FIG. 3 is a side view of an image light guide including an interference filter according to an exemplary embodiment of the presently disclosed subject matter.

FIG. 4 is an enlarged view of section 4 illustrated in FIG. 3.

FIG. 5 illustrates an exemplary spectral distribution of an image source according to an exemplary embodiment of the presently disclosed subject matter.

FIG. 6 illustrates an idealized spectral transmittance curve of an interference filter according to an exemplary embodiment of the presently disclosed subject matter.

FIG. 7 illustrates an exemplary spectral transmittance curve of an interference filter according to an exemplary embodiment of the presently disclosed subject matter.

FIG. 8 is a side view of an image light guide including an interference filter and an absorber layer according to an exemplary embodiment of the presently disclosed subject matter.

FIG. 9 illustrates an exemplary spectral transmittance curve of an interference filter and an exemplary absorber transmittance curve of an absorber layer according to an exemplary embodiment of the presently disclosed subject matter.

FIG. 10 illustrates an exemplary net transmittance curve according to an exemplary embodiment of the presently disclosed subject matter.

FIG. 11 is a side view of an image light guide including an interference filter and an absorber layer according to an exemplary embodiment of the presently disclosed subject matter.

FIG. 12 illustrates perspective view of an image light guide system taking the form of a head-mounted display according to an exemplary embodiment of the presently disclosed subject matter.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

One skilled in the relevant art will recognize that the elements and techniques described herein can be practiced without one or more of the specific details, or with other methods, components, materials, etc. In some instances, well-known structures, materials, or operations are not shown or described in detail to avoid obscuring certain aspects of the present disclosure. Reference throughout the specification to “one embodiment” or “an embodiment” means that a particular feature, structure, or characteristic described in connection with the embodiment is included in at least one embodiment of the present disclosure. Thus, the appearance of the phrase “in one embodiment” or “in an embodiment” throughout the specification is not necessarily referring to the same embodiment. However, the particular features, structures, or characteristics described may be combined in any suitable manner in one or more embodiments.

While a transparent waveguide can be shaped in different ways, such as for contributing optical power, waveguides having a thin plate-shaped form provide both functional and manufacturing advantages. For example, plate-shaped waveguides with plane-parallel front and back surfaces provide a reliable way of preserving the angular encoding of beams propagating by the mechanism of total internal reflection (TIR) between the in-coupling and out-coupling optics. The plate-shaped form is also easier to manufacture to high tolerances and can reduce the size, weight, and cost of the image light guides.

The in-coupling optic, which can also take a variety of forms including prisms, mirrors, or diffractive optics, directs the angularly related beams from the image generator into the waveguide. For example, such diffractive optics can be formed as diffraction gratings, surface relief gratings, volume holograms, holographic optical elements, or liquid crystal material that can be mounted on the front or back surface of the planar waveguide or formed in the waveguide.

The out-coupling optic can take similar forms, but to preserve a view of the ambient environment through the waveguide, the out-coupling optic should avoid distorting or otherwise impairing the wearer's view of the real world. As a diffractive optic, the out-coupling optic can be matched with the in-coupling diffractive optic to decode any angular encoding imposed by the in-coupling diffractive optic. In addition, the efficiency of the out-coupling diffractive optic can be controlled to support multiple encounters with the angularly related beams propagating along the waveguide to effectively reproduce each beam so that beams diffracted from the waveguide overlap over a larger area within which the virtual image can be seen by the wearer's eye (i.e., provide eyebox expansion).

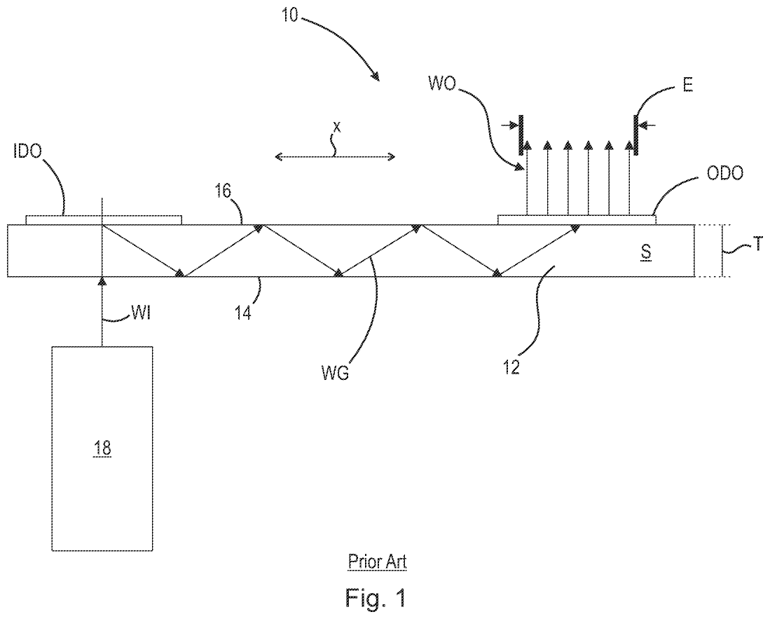

FIG. 1 is a schematic diagram showing a simplified cross-sectional view of one conventional configuration of an image light guide 10. Image light guide 10 includes a planar waveguide 12, an in-coupling diffractive optic IDO, and an out-coupling diffractive optic ODO. The planar waveguide 12 includes a transparent substrate S, which can be made of optical glass or plastic, with plane-parallel front and back surfaces 14 and 16. In this example, the in-coupling diffractive optic IDO is shown as a reflective-type diffraction grating arranged on the back surface 16 of the planar waveguide 12. However, in-coupling diffractive optic IDO could alternately be a transmissive-type diffraction grating or other type of diffractive optic, such as a volume hologram or other holographic diffraction element, or liquid crystal material, that diffracts incoming image-bearing light beams WI into the planar waveguide 12. The in-coupling diffractive optic IDO can be located on front surface 14 or back surface 16 of the planar waveguide 12 and can be of a transmissive or reflective-type in a combination that depends upon the direction from which the image-bearing light beams WI approach the planar waveguide 12.

When used as a part of a near-eye display system, the in-coupling diffractive optic IDO couples the image-bearing light beams WI from a real, virtual or hybrid image source 18 into the substrate S of the planar waveguide 12. Any real image or image dimension formed by the image source 18 is first converted, e.g., converged toward a focus, into an array of overlapping, angularly related beams encoding the different positions within a virtual image for presentation to the in-coupling diffractive optic IDO. Typically, the rays within each bundle forming one of the angularly related beams extend in parallel, but the angularly related beams are relatively inclined to each other through angles that can be defined in two angular dimensions corresponding to linear dimensions of the image.

Once they pass through the transparent substrate S, the image-bearing light beams WI are diffracted (generally through a first diffraction order) and thereby redirected by in-coupling diffractive optic IDO into the planar waveguide 12 as angularly encoded image-bearing light beams WG for further propagation along a length dimension X of the planar waveguide 12 by TIR from the plane parallel front and back surfaces 14 and 16. Although diffracted into a different combination of angularly-related beams in keeping with the boundaries set by TIR, the image-bearing light beams WG preserve the image information in an angularly encoded form that is derivable from the parameters of the in-coupling diffractive optic IDO. The out-coupling diffractive optic ODO receives the encoded image-bearing light beams WG and diffracts (also generally through a first diffraction order) the image-bearing light beams WG out of the planar waveguide 12, as image-bearing light beams WO, toward a nearby region of space referred to as an eyebox E, within which the transmitted virtual image can be seen by a viewer's eye. The out-coupling diffractive optic ODO can be designed symmetrically with respect to the in-coupling diffractive optic IDO to restore the original angular relationships of the image-bearing light beams WI among outputted angularly related beams of the image-bearing light beams WO. In addition, the out-coupling diffractive optic ODO can modify the original field points' positional angular relationships producing an output virtual image at a finite focusing distance.

However, to increase one dimension of overlap among the angularly related beams populating the eyebox E (defining the size of the region within which the virtual image can be seen), the out-coupling diffractive optic ODO is arranged together with a limited thickness T of the planar waveguide 12 to encounter the image-bearing light beams WG multiple times and to diffract only a portion of the image-bearing light beams WG upon each encounter. The multiple encounters along the length of the out-coupling diffractive optic ODO have the effect of enlarging at least one dimension of each of the angularly related beams of the image-bearing light beams WO thereby expanding at least one dimension of the eyebox E within which the beams overlap. The expanded eyebox E decreases sensitivity to the position of a viewer's eye for viewing the virtual image.

The out-coupling diffractive optic ODO is shown as a transmissive-type diffraction grating arranged on or secured to the back surface 16 of the planar waveguide 12. However, like the in-coupling diffractive optic IDO, the out-coupling diffractive optic ODO can be located on the front or back surface 14 or 16 of the planar waveguide 12 and can be of a transmissive or reflective-type in a combination that depends upon the direction through which the image-bearing light beams WG is intended to exit the planar waveguide 12. In addition, the out-coupling diffractive optic ODO could be formed as another type of diffractive optic, such as a volume hologram or other holographic diffraction element, or liquid crystal material, that diffracts propagating image-bearing light beams WG from the planar waveguide 12 as the image-bearing light beams WO propagating toward the eyebox E.

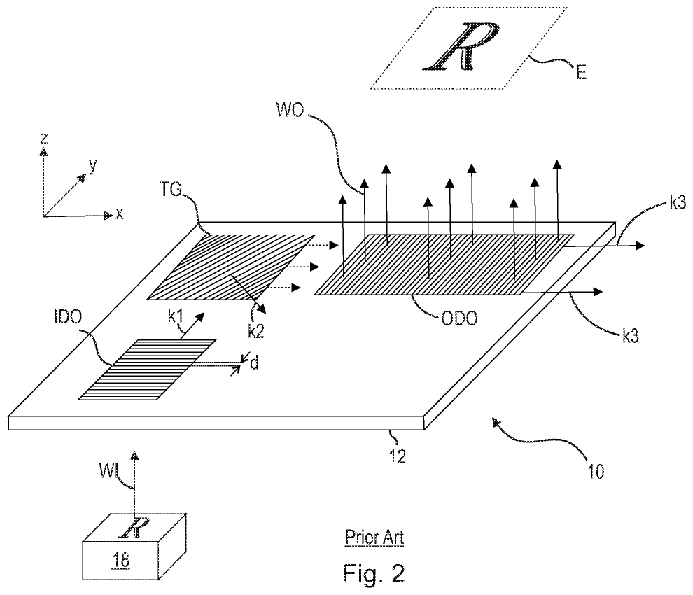

FIG. 2 illustrates a perspective view of a conventional image light guide 10 arranged for expanding the eyebox E in two dimensions, i.e., along both x- and y-axes of the intended image. To achieve a second dimension of eyebox expansion, the in-coupling diffractive optic IDO is oriented to diffract the image-bearing light beams WG about a grating vector k1 along the planar waveguide 12 toward an intermediate turning optic TO, whose grating vector k2 is oriented to diffract the image-bearing light beams WG in a reflective mode along the planar waveguide 12 toward the out-coupling diffractive optic ODO. Only a portion of the image-bearing light beams WG are diffracted by each of multiple encounters with intermediate turning optic TO thereby laterally replicating each of the angularly related beams of the image-bearing light beams WG as they approach the out-coupling diffractive optic ODO. The intermediate turning optic TO redirects the image-bearing light beams WG into alignment, or into approximate alignment, with a grating vector k3 of the out-coupling diffractive optic ODO for longitudinally replicating the angularly related beams of the image-bearing light beams WG in a second dimension before exiting the planar waveguide 12 as the image-bearing light beams WO. Grating vectors, such as the depicted grating vectors k1, k2, and k3, extend within a parallel plane of the planar waveguide 12 in respective directions that are normal to the diffractive features (e.g., grooves, lines, or rulings) of the diffractive optics and have respective magnitudes inverse to the period or pitch d (i.e., the on-center distance between the diffractive features) of the diffractive optics IDO, TO, and ODO.

As shown in FIG. 2, in-coupling diffractive optic IDO receives the incoming image-bearing light beams WI containing a set of angularly related beams corresponding to individual pixels or equivalent locations within an image generated by the image source 18, such as a projector. A full range of angularly encoded beams for producing a virtual image can be generated by a real display together with focusing optics, by a beam scanner for more directly setting the angles of the beams, or by a combination such as a one-dimensional real display used with a scanner. In this configuration, the image light guide 10 outputs an expanded set of angularly related beams in two dimensions by providing multiple encounters of the image-bearing light beams WG with both the intermediate turning optic TO and the out-coupling diffractive optic ODO in different orientations. In the depicted orientation of the planar waveguide 12, the intermediate turning optic TO provides eyebox expansion in the y-axis direction, and the out-coupling diffractive optic ODO provides a similar eyebox expansion in the x-axis direction. The relative orientations and respective periods d of the diffractive features of the in-coupling optic IDO, intermediate turning optic TO, and out-coupling diffractive optic ODO provide for eyebox expansion in two dimensions while preserving the intended relationships among the angularly related beams of the image-bearing light beams WI that are output from the image light guide 10 as the image-bearing light beams WO.

In the configuration shown, while the image-bearing light beams WI input into the image light guide 10 are encoded into a different set of angularly related beams by the in-coupling diffractive optic IDO, the information required to reconstruct the image is preserved by accounting for the systematic effects of the in-coupling diffractive optic IDO. The intermediate turning optic TO, located in an intermediate position between the in-coupling and out-coupling diffractive optics IDO and ODO, can be arranged so that it does not induce significant changes to the encoding of the image-bearing light beams WG. As such, the out-coupling diffractive optic ODO can be arranged in a symmetric fashion with respect to the in-coupling diffractive optic IDO, e.g., including diffractive features sharing the same period d. Similarly, the period of the intermediate turning optic TO can also match the common period of the in-coupling and out-coupling diffractive optics IDO and ODO. Although the grating vector k2 of the intermediate turning optic TO is shown oriented at 45 degrees with respect to the other grating vectors, which remains a possible orientation, the grating vector k2 of the intermediate turning optic TO can be oriented at 60 degrees to the grating vectors k1 and k3 of the in-coupling and out-coupling diffractive optics IDO and ODO in such a way that the image-bearing light beams WG is turned 120 degrees. By orienting the grating vector k2 of the intermediate turning optic TO at 60 degrees with respect to the grating vectors k1 and k3 of the in-coupling and out-coupling diffractive optics IDO and ODO, the grating vectors k1 and k3 of the in-coupling and out-coupling diffractive optics IDO and ODO are also oriented at 60 degrees with respect to each other. By basing the grating vector magnitudes on the common pitch shared by the in-coupling, intermediate turning, and out-coupling diffractive optics IDO, TO, and ODO, the three grating vectors k1, k2, and k3 (as directed line segments) form an equilateral triangle and sum to a zero vector magnitude, which avoids asymmetric effects that could introduce unwanted aberrations including chromatic dispersion. Such asymmetric effects can also be avoided by grating vectors k1, k2, and k3 that have unequal magnitudes in relative orientations at which the three grating vectors k1, k2, and k3 sum to a zero vector magnitude.

In a broader sense, the image-bearing light beams WI that are directed into the planar waveguide 12 are effectively encoded by the in-coupling diffractive optic IDO, whether the in-coupling optic IDO uses gratings, holograms, prisms, mirrors, liquid crystal material, or some other mechanism. Any reflection, refraction, and/or diffraction of light that takes place at the input should be correspondingly decoded by the output to re-form the virtual image that is presented to the viewer. Whether any symmetries are maintained among the intermediate turning optic TO, the in-coupling optic IDO, and out-coupling diffractive optic ODO, or whether any change to the encoding of the angularly related beams of the image-bearing light beams WI takes place along the planar waveguide 12, the intermediate turning optic TO and the in-coupling and out-coupling diffractive optics IDO and ODO can be related so that the image-bearing light beams WO that are output from the planar waveguide 12 preserve or otherwise maintain the original or desired form of the image-bearing light beams WI for producing the intended virtual image.

As shown in FIG. 2, the letter “R” represents the orientation of the virtual image that is visible to the viewer whose eye is positioned within the eyebox E. As shown, the orientation of the letter “R” in the represented virtual image matches the orientation of the letter “R” as encoded by the image-bearing light beams WI. A change in the rotation about the z axis or angular orientation of incoming image-bearing light beams WI with respect to the x-y plane causes a corresponding symmetric change in rotation or angular orientation of outgoing light from out-coupling diffractive optic (ODO). From the aspect of image orientation, the intermediate turning optic TO simply acts as a type of optical relay, providing expansion of the angularly encoded beams of the image-bearing light beams WG along one axis (e.g., along the y axis) of the image. Out-coupling diffractive optic ODO further expands the angularly encoded beams of the image-bearing light beams WG along another axis (e.g., along the x axis) of the image while maintaining the original orientation of the virtual image encoded by the image-bearing light beams WI. The intermediate turning optic TO is typically a slanted or square grating or, alternately, can be a blazed grating and is typically arranged on one of the plane parallel front and back surfaces of the planar waveguide 12. It should be appreciated that the representation of the virtual image “R” as created by an image source is comprised of infinitely focused light that requires a lens (e.g., the lens in the human eye) to focus the image so that the orientations discussed above can be detected.

Together, the in-coupling, turning, and out-coupling diffractive optics IDO, TO, and ODO preferably preserve the angular relationships among beams of different wavelengths defining a virtual image upon conveyance by image light guide 10 from an offset position to a near-eye position of the viewer. While doing so, the in-coupling, turning, and out-coupling diffractive optics IDO, TO, and ODO can be relatively positioned and oriented in different ways to control the overall shape of the planar waveguide 12 as well as the overall orientations at which the angularly related beams can be directed into and out of the planar waveguide 12.

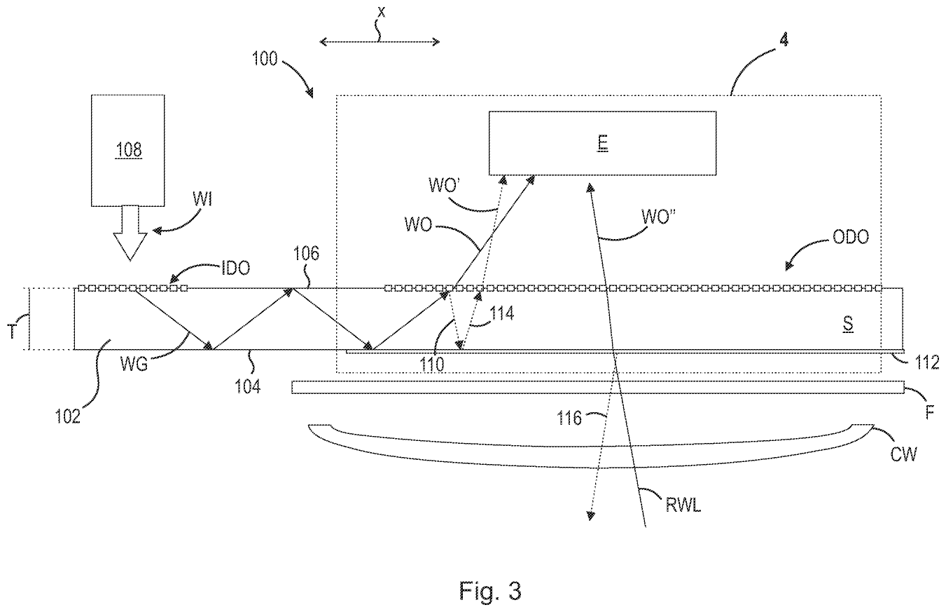

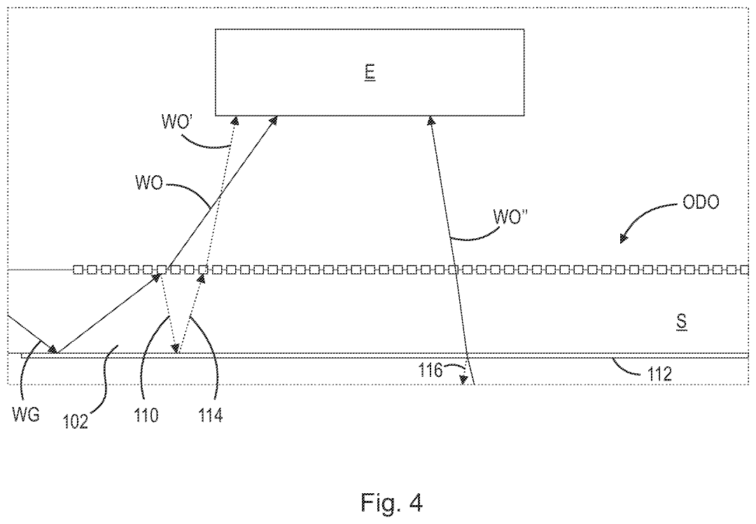

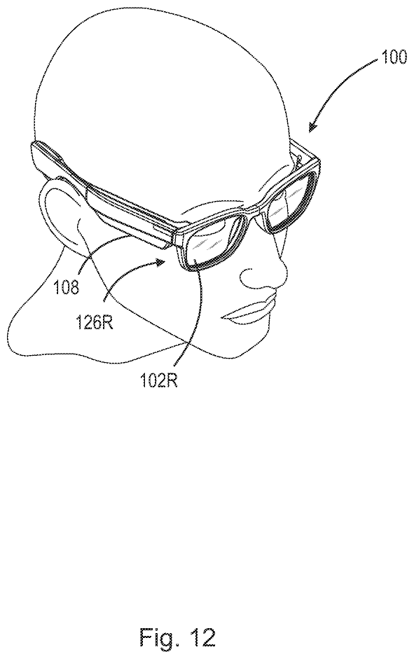

FIG. 3 shows an example image light guide system 100 according to the present disclosure. FIG. 4 illustrates a close-up view of portion 4 shown in FIG. 3. As shown in FIGS. 3-4, the example image light guide system 100 includes an image light guide 102 (in the form of a planar waveguide), an in-coupling diffractive optic IDO, and an out-coupling diffractive optic ODO. Although illustrated as a planar waveguide, it should be appreciated that image light guide 102 can be a non-planar waveguide, e.g., a curved waveguide. In some examples, image light guide system 100 can take the form of a head-mounted display (shown in FIG. 12) or other head-mounted optical system. As shown, the image light guide 102 includes a transparent substrate S, which can be made of optical glass or plastic, with plane-parallel front and back surfaces 104 and 106, respectively. In this example, the in-coupling diffractive optic IDO is shown as a transmissive-type diffraction grating arranged on or within the back surface 106 of the image light guide 102. However, in-coupling diffractive optic IDO could alternately be a reflective-type diffraction grating or other type of diffractive optic, such as a volume hologram or other holographic diffraction element, or liquid crystal material, that diffracts incoming image-bearing light beams WI into the image light guide 102. The in-coupling diffractive optic IDO can be located on or within front surface 104 or back surface 106 of image light guide 102 and can be of a transmissive or reflective-type. Image light guide system 100 can also include a cover window CW or other transparent or translucent cover material disposed between the image light guide 102 and the environment. In one example, cover window CW forms a portion of a frame, e.g., eyeglass frames, and is configured to surround and at least partially secure at least one image light guide 102 to the frame. Optionally, a filter F or filter material can be positioned between the image light guide 102 and the cover window CW. Filter F can include one or more optical structures or materials configured to transmit certain portions of electromagnetic radiation while reflecting, absorbing, or otherwise attenuating others. In one example, filter F can be a polarizer or polarizing material configured to reduce the transmittance of electromagnetic radiation that passes through the image light guide system 100 and enters a user's eye(s). In some embodiments, as will be discussed in detail below, anti-reflective coatings can be provided on front surface 104, back surface 106, and/or the front or back surface of cover window CW.

As shown in FIG. 3, the image light guide system 100 includes an image source 108. In some examples, image source 108 comprises one or more light-emitting diodes (LEDs), organic LEDs (OLEDs), or ultra LEDs (μLEDs). In other examples, image source 108 is a color field sequential projector system operable to pulse image-bearing light of multiple wavebands, for example light from within red, green, and blue wavelength ranges, onto a digital light modulator/micro-mirror array (a “DLP”) or a liquid crystal on silicon (“LCOS”) display. In further examples, image source 108 includes one or more pico-projectors, where each pico-projector is configured to produce a single primary color band (e.g., red, green, or blue). In another example, image source 108 includes a single pico-projector arranged to produce all three primary color bands (e.g., red, green, and blue). In one example, the three primary color bands are a green band having a wavelength in the range between 495 nm and 570 nm, a red band having a wavelength in the range between 620 nm and 750 nm, and a blue band having a wavelength in the range between 450 nm and 495 nm. The light generated by the pico-projector, once coupled and transmitted through image light guide 102, can be used by image light guide system 100 to form one or more virtual images viewable by a user's eye positioned within the eyebox E.

Similar to the in-coupling diffractive optic IDO described with respect to FIGS. 1 and 2, the in-coupling diffractive optic IDO of the example shown in FIG. 3 couples the image-bearing light beams WI from a real, virtual or hybrid image source 108 into the substrate S of the image light guide 102. Any real image or image dimension formed by the image source 108 is first converted, e.g., converged toward a focus, into an array of overlapping, angularly related beams encoding the different positions within a virtual image for presentation to the in-coupling diffractive optic IDO. The rays within each bundle that form one of the angularly related beams extend in parallel, but the angularly related beams are relatively inclined to each other through angles that can be defined in two angular dimensions corresponding to linear dimensions of the image.

As shown in FIGS. 3-4, as image-bearing light beams WI engage with the optical features of in-coupling diffractive optic IDO, they are diffracted (generally through a first diffraction order) and at least a portion of the image-bearing light beams WI are thereby redirected by the in-coupling diffractive optic IDO into the image light guide 102 as angularly encoded image-bearing light beams WG for further propagation along a length dimension x of the image light guide 102 by TIR from the plane parallel front and back surfaces 104 and 106. The terms “coupling” and/or “optical coupling,” in addition to their ordinary meaning to those with skill in the art, may be utilized herein to refer to this redirection of image-bearing light beams WI, such that angularly encoded image-bearing light beams WG can propagate between front surface 104 and back surface 106 within the image light guide 102. Although diffracted into a different combination of angularly related beams in keeping with the boundaries set by TIR, the image-bearing light beams WG preserve the image information in an angularly encoded form that is derivable from the parameters of the in-coupling diffractive optic IDO.

Once coupled into the image light guide 102, angularly encoded image-bearing light beams WG propagate within the image light guide 102 until they encounter the portion of the image light guide 102 that includes out-coupling diffractive optic ODO. As described above with respect to FIGS. 1 and 2, the out-coupling diffractive optic ODO shown in the example depicted in FIG. 3 receives the encoded image-bearing light beams WG and diffracts (also generally through a first diffraction order) at least a portion of the image-bearing light beams WG out of the image light guide 102, as image-bearing light beams WO, toward an eyebox E. The out-coupling diffractive optic ODO can be designed symmetrically with respect to the in-coupling diffractive optic IDO to restore the original angular relationships of the image-bearing light beams WI among outputted angularly related beams of the image-bearing light beams WO. In addition, in an embodiment, the out-coupling diffractive optic ODO can modify the original field points' positional/angular relationships producing an output virtual image at a finite or infinite focusing distance.

Additionally, to increase at least one dimension of overlap among the angularly related beams populating the eyebox E (defining the size of the region within which the virtual image can be seen), the out-coupling diffractive optic ODO is arranged together with a limited thickness T of the image light guide 102 to encounter the image-bearing light beams WG multiple times and to diffract only a portion of the image-bearing light beams WG upon each encounter. The portion of angularly encoded image-bearing light beams WG that is diffracted out of the out-coupling diffractive optic ODO forms decoded image-bearing light beams WO. The multiple encounters along the length of the out-coupling diffractive optic ODO have the effect of enlarging at least one dimension of each of the angularly related beams of the image-bearing light beams WO, thereby expanding at least one dimension of the eyebox E within which the beams overlap. This expansion within the eyebox E decreases sensitivity to the position of a viewer's eye for viewing the virtual image, or virtual images, generated.

Although each encounter along the length of the out-coupling diffractive optic ODO diffracts a portion of the angularly encoded image-bearing light WG out of the image light guide 102 as angularly decoded image-bearing light beams WO, another portion of the angularly encoded image-bearing light WG, i.e., first reflected portion 110, is reflected or diffracted from the periodic structures that comprise the out-coupling diffractive optic ODO toward the front surface 104 at an angle that does not preserve its coupling within the image light guide 102, i.e., at an angle greater than the critical angle for TIR. If not addressed, upon encountering the interface between front surface 104 and the surrounding air of the environment, reflected portion 110 would refract through and exit from front surface 104 of image light guide 102 and propagate into the environment. This “leaked” light, or “forward light leakage” is undesirable as it could compromise the privacy of the user by allowing observers within the environment to see the contents of the leaked image-bearing light. The reflected portion 110 that leaks from the image light guide 102 also represents an inefficiency in image formation in the eyebox E as any light leaked from the front surface 104 of the image light guide 102 is image-bearing light that does not operate to form an image within the eyebox E.

As shown in FIGS. 3 and 4, in one example embodiment according to the present disclosure, image light guide system 100 further includes an interference reflector or interference filter 112 positioned on or engaged with front surface 104 of image light guide 102. Interference filter 112 is intended to be a thin-film interference filter or other optical filter configured to reflect at least one range of wavelengths incident on the interference filter 112, while allowing transmittance of all other wavelengths through the filter. In one example, interference filter 112 is a thin-film interference filter configured to reflect a range of wavelengths of electromagnetic radiation within the visible spectrum, while allowing all other wavelengths of light to pass through. In one example, interference filter 112 is configured to reflect a range of wavelengths of light between 495 nm and 570 nm, i.e., substantially green light, while transmitting light with wavelengths outside of that range (i.e., above 570 nm and below 495 nm). In other examples, interference filter 112 is configured to reflect a range of wavelengths between 450 nm to 495 nm (i.e., substantially blue light) or a range of wavelengths between 620 nm to 750 nm (i.e., substantially red light) while transmitting all other wavelengths. It should be appreciated that reflectance of other wavelength ranges using interference filter 112 is possible, e.g., reflectance of light within the Ultraviolet (UV) and/or Infrared (IR) wavelength ranges is possible. It should be appreciated that interference filter 112 can also be selected from at least one of a dielectric interference filter, a non-dielectric interference filter, or a wavelength selective reflector or partial reflector.

As described above and as illustrated in FIGS. 3 and 4, interference filter 112 is positioned on, embedded within, or engaged with front surface 104 of image light guide 102. By positioning the interference filter 112 in this way, light of the reflected portion of light 110 (reflected upon engagement with the optical features of the out-coupling diffractive optic ODO) that has a wavelength within the range reflected by the interference filter 112, will not exit the image light guide 102 as leaked light and instead will be reflected from the interference filter 112 back toward the out-coupling diffractive optic ODO and into the eyebox E. By reflecting the light, that would otherwise be leaked, back into the image light guide 102, and back toward the eyebox E, the system efficiency, and therefore the brightness of the virtual image formed in the eyebox E, can be increased.

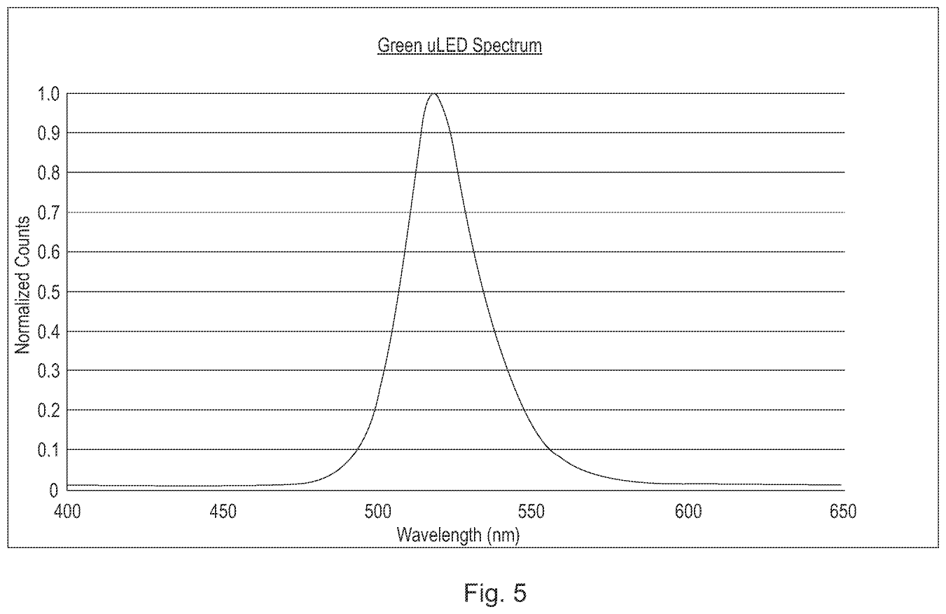

With continued reference to FIGS. 3 and 4, in one operational example, the image light guide system 100 includes an image source 108 configured to produce virtual images using a spectral distribution of light substantially comprised of one waveband or bandwidth of light, e.g., green light. One example spectral distribution of such an image source 108 is illustrated in FIG. 5. As shown, a significant portion, e.g., greater than 95%, of the wavelengths of light fall within a wavelength bandwidth between 495 nm and 570 nm. The graph shown in FIG. 5 illustrates wavelength (horizontal axis) vs. normalized counts (vertical axis) of an optical output from a uLED image source, e.g., image source 108, that is configured to produce one or more images using substantially green light, i.e., light from within the range of 495 nm to 570 nm. The term “normalized counts” as used herein, refers to values obtained by a spectrometer when the spectrometer is uncalibrated. As shown in FIG. 5, the relative count data is normalized to 1 to show the relative distribution of wavelengths. In this operational example of the image light guide system 100, substantially green light is used to form one or more virtual images, as green light has a higher coupling efficiency into the image light guide 102 as compared to substantially red or substantially blue light. Hence, virtual images that are formed with substantially green light tend to be brighter as viewed by the user.

In this operational example, and as illustrated in FIGS. 3 and 4, an interference filter 112 can be selected to reflect a portion of electromagnetic radiation that corresponds to the waveband of light used by the image source 108. As such, the interference filter 112 is selected so that it reflects wavelengths of light from the green portion of the visible spectrum, while allowing all other wavelengths of light to transmit through the interference filter 112. As such, any green light reflected from the periodic/optical features of the out-coupling diffractive optic ODO, i.e., reflected portion 110, that would otherwise exit front surface 104 of the image light guide 102, is reflected back, as sub-portion 114 (shown in FIGS. 3 and 4), upon contacting the interference filter 112. As such, green light is reflected toward the out-coupling diffractive optic ODO and exits the image light guide 102 through back surface 106 and propagates toward the eyebox E as image-bearing light WO′. By reflecting green light that would otherwise leak from the front surface 104 of the image light guide 102 back to the eyebox E, the image light guide 102 will have a higher coupling efficiency, and the virtual images formed within the eyebox E that use green light will appear brighter. Additionally, as reflected portion 110 does not exit the front surface 104 of the image light guide 102, the amount of forward-leaking light exiting the image light guide is substantially mitigated, improving the privacy of the user with respect to the formation of virtual images.

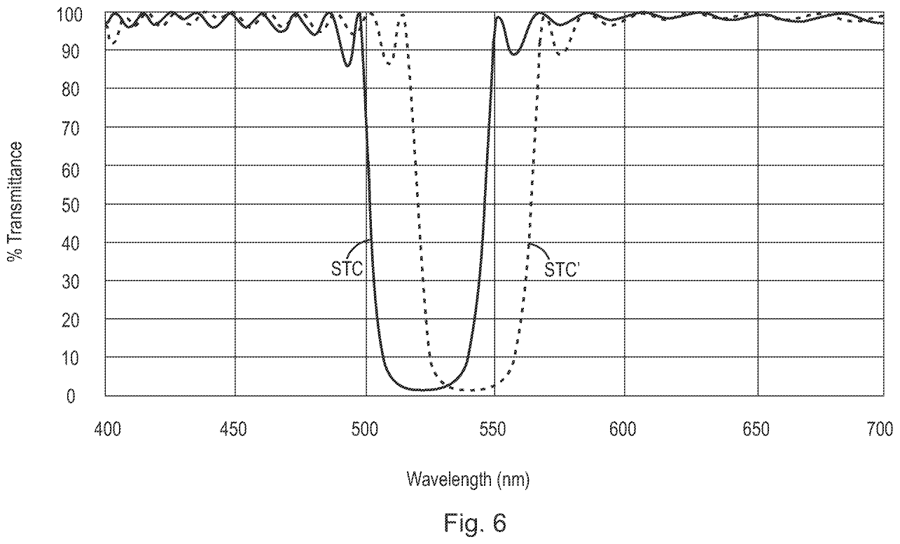

FIG. 6 illustrates an example of an idealized spectral transmittance of interference filter 112. As shown, the spectral transmittance curve STC is centered between 520 nm and 525 nm and has a bandwidth of approximately 40 nm to 50 nm such that it encompasses a substantial portion of the wavelengths of the green portion of the visible spectrum. In addition to the approximate bandwidth shown, in the idealized spectral transmittance curve STC, the percentage of transmittance of the green light approaches zero at its peak (lowest point in the curve). In other words, a substantial portion (approaching zero percent) of the green light that contacts this idealized interference filter 112 will be reflected. Additionally, as shown, the position of the transmittance curve may be angularly dependent on the angle of incidence of the light that it interacts with. For example, the idealized interference filter 112 can receive light from a range of incident angles, i.e., angles of incidence (AOI) between 0 degrees and 25 degrees. In other examples, the idealized interference filter can receive light from within a range of AOI between 0 degrees and 22 degrees. As shown in FIG. 6, spectral transmittance curve STC (shown as a solid line) represents the spectral transmittance of light received from an AOI of 0 degrees. FIG. 6 also illustrates a spectral transmittance curve STC' (shown as a dotted line) which represents the spectral transmittance of light with an AOI of 22 degrees. It should be appreciated that, as the AOI of the incident light upon the idealized interference filter 112 changes, so too does the position of the spectral transmittance curve. As such, the spectral transmittance curve is dependent on the AOI of the incident light and could occupy a position on the graph illustrated at various points between spectral transmittance curve STC and spectral transmittance curve STC' as a function of that dependence.

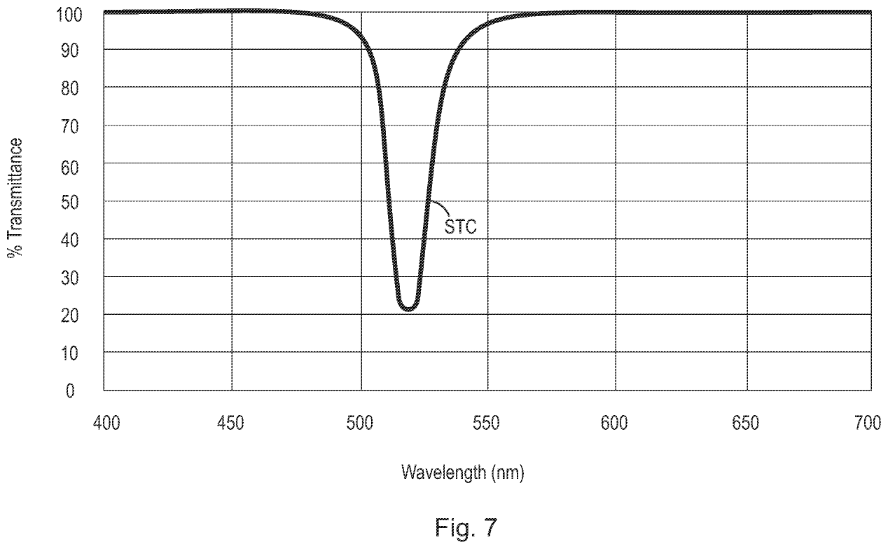

FIG. 7 illustrates another graph showing another example of the spectral transmittance curve STC of an interference filter 112. As shown, the spectral transmittance curve STC is centered between 515 nm and 525 nm. In some examples, the spectral transmittance curve STC is centered at 519 nm. As shown, and unlike the idealized transmittance curve STC shown in FIG. 6, the spectral transmittance curve STC shown in FIG. 7 illustrates a steeper and narrower curve, and rather than approaching zero percent transmittance in the green spectrum, the lowest percentage of transmittance is between 20% and 25%. In some examples, the material for the interference filter 112 and/or the angle of incidence (AOI) of the light that engages with interference filter 112 can be adjusted such that the total transmittance within the green spectrum is between 20% and 40%, and in other examples a total transmittance between 25% and 50%. Although not illustrated in FIG. 7, it should be appreciated that the interference filter 112 used to form the spectral transmittance curve STC can exhibit angular dependency with respect to the angle of incidence of the light it engages with, as described above with respect to the graph illustrated in FIG. 6.

As a result of introducing interference filter 112 between the image light guide 102 and the environment in front of the user, i.e., forward of the front surface 104, light from real-world objects in the environment must pass through both the image light guide 102 and the interference filter 112 to reach the eyebox E and form real-world images in the user's eye. As such, by placing interference filter 112 between light reflected from the real-world objects and the eyebox E, at least a portion of light reflected from real-world objects that contains light from within the range of wavelengths reflected by the interference filter 112 will not reach the user's eye. For example, as set forth in the operational example above, the interference filter 112 (configured to reflect substantially green light) will also reflect a portion of any green light that would have otherwise been received by the user's eye from real-world objects. In other words, the user would see a small to absolute reduction in green light in real-world images as the amount of green light that would pass through the filter has been diminished. Because the human eye interprets color using receptors for red, green, and blue, by removing green light from real-world images, the user may perceive all real-world objects as having a pink/magenta color or hue as the real-world images will be dominated by a mix of the remaining primary colors, i.e., red and blue.

Reverting to FIGS. 3 and 4, the foregoing example is illustrated as real-world light RWL that is incident on image light guide 102 and/or on interference filter 112. As shown, real-world light RWL must pass through cover window CW, filter F, interference filter 112 and image light guide 102 to form real-world image-bearing light WO″ within the eyebox E. As the real-world light RWL engages with interference filter 112, a sub-portion of real-world light RWL, shown as sub-portion 116, is reflected toward the environment and never reaches the eyebox E, and is therefore not used to form an image within the user's eye. Continuing with the operational example above, if the interference filter 112 is configured to reflect substantially green light, then sub-portion 116 of real-world light RWL will be substantially green light reflected toward the environment. As such, a substantial portion of green light from the real-world light RWL will not reach the user's eye, and images formed in the user's eye from the real-world will appear pink/magenta as they will be dominated by light from within the red and blue portions of the visible spectrum.

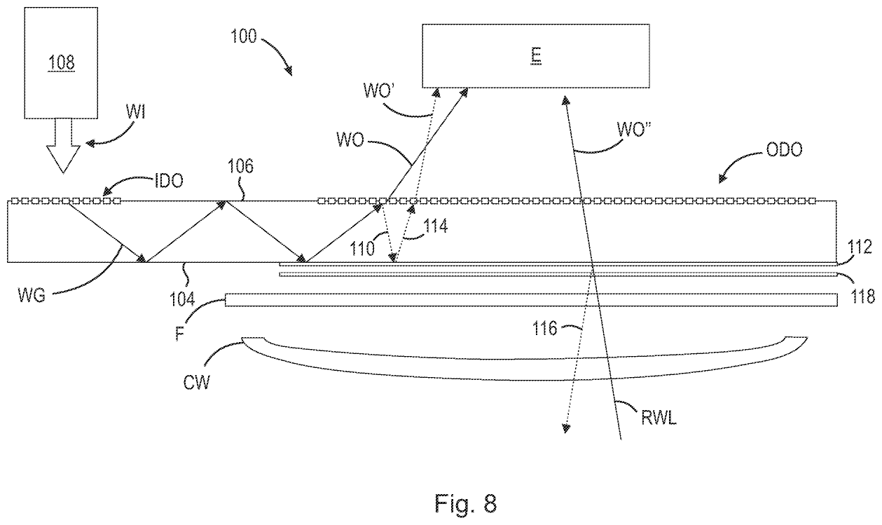

Therefore, it is a further object of the present disclosure to provide an image light guide system 100 that addresses this pink/magenta result. As such, in one example shown in FIG. 8, image light guide system 100 further includes an absorber layer 118 configured to counteract the pink/magenta effect on the real-world images formed in the user's eye. As illustrated, the absorber layer 118 is positioned outside of interference filter 112, that is, between interference filter 112 and the cover window CW. However, it should be appreciated that absorber layer 118 can be positioned at any position or location between the user's eyes and the environment, e.g., between the filter F and the cover window CW, on either the inner or outer surfaces of the cover window CW, or on or within back surface 106 of image light guide 102. In an embodiment, the absorber layer 118 is a thin-film gel material secured to any of these surfaces, such as a thin-film absorber gel from Rosco Laboratories Inc., located 52 Harbor View, Stamford, CT, USA. The absorber layer 118 can also be a dye or pigment mixed into or layered over any of the surfaces discussed above. For example, an absorptive pigment could be mixed with the transparent material used to make image light guide 102 or could be layered over front surface 104 or back surface 106 of the image light guide 102. An absorptive pigment could also be mixed with or layered over the material used to make cover window CW.

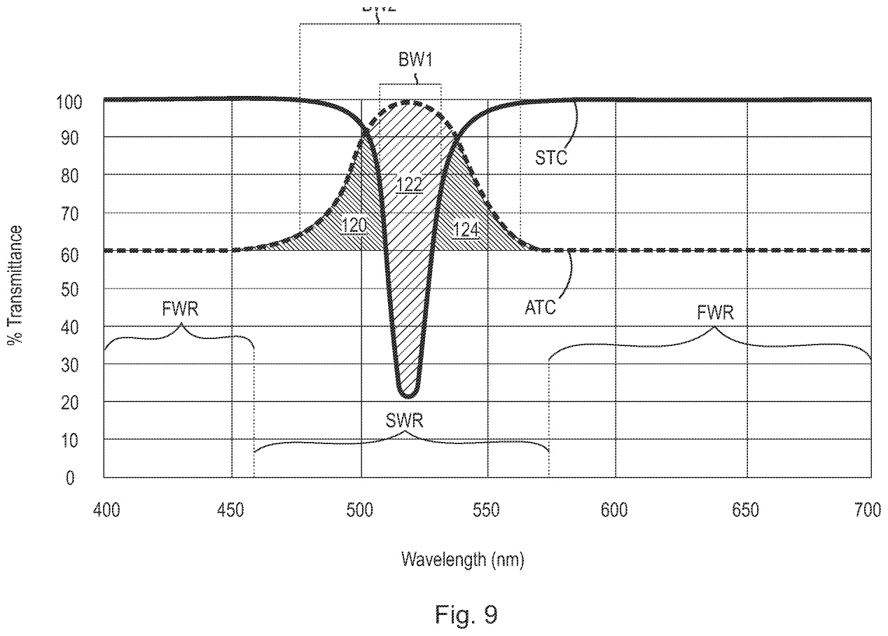

FIG. 9 illustrates two overlapping transmittance curves, i.e., the spectral transmittance curve STC shown in FIG. 7 (corresponding to the spectral transmittance of interference filter 112) and an absorber transmittance curve ATC corresponding to the spectral transmittance of the absorber layer 118. In one example, as illustrated in FIG. 9, the absorber transmittance curve ATC allows transmittance of approximately 60% of all wavelengths of light shown, except for a single bandwidth of light, i.e., bandwidth BW2, centered between 515 nm and 525 nm. Within that bandwidth BW2, i.e., a bandwidth that substantially encompasses wavelengths associated with green light, transmittance is allowed in excess of 95%. By reducing transmittance of wavelengths of light outside of the green spectrum, all other colors will appear slightly muted or “greyed out,” while light within the green portion of the spectrum will be allowed to transmit without significant mitigation. It should be appreciated that although the absorber transmittance curve ATC is illustrated as allowing approximately 60% of the full spectrum light through the absorber layer 118, other spectral transmittance percentages are possible, e.g., the transmittance percentages outside of the boosted green bandwidth BW2 can be selected from the range of 20%-80%. It should also be appreciated that the bandwidth of the absorber transmittance curve ATC (i.e., bandwidth BW2) is greater than the bandwidth of the spectral transmittance curve STC (i.e., bandwidth BW1) associated with interference filter 112.

As illustrated in FIG. 8, the interference filter 112 and the absorber layer 118 can at least partially overlap, and therefore, any images formed within the eyebox E will be the net effect of light transmitted through both the interference filter 112 and the absorber layer 118. As shown in FIG. 9, the bandwidth of the absorber transmittance curve ATC, i.e., bandwidth BW2, is broader or wider than the bandwidth of the spectral transmittance curve STC, i.e., bandwidth BW1, associated with the interference filter 112. The larger bandwidth BW2 of the absorber transmittance curve ATC with respect to the narrower bandwidth BW1 of the interference filter 112 creates three distinct regions in the overlapping curves shown in FIG. 9, e.g., a left absorber region 120, a central absorber region 122, and a right absorber region 124. As the absorber layer 118 can have a transmittance rate of approximately 60% with respect to a first wavelength range FWR, i.e., wavelengths outside of the green spectrum (e.g., wavelengths above 570 nm and below 460 nm) of light within the first wavelength range FWR will appear muted or “greyed out.” Thus, the left absorber region 120, the central absorber region 122, and the right absorber region 124 represent portions of the total spectral transmittance where the transmittance of light is not greyed out and is instead boosted with respect to all other spectrums of light passing through the absorber layer 118. In other words, wavelengths of light within this second wavelength range SWR will have boosted transmittance with respect to all other wavelengths. Additionally, left absorber region 120 and right absorber region 124 represent portions of the boosted spectrum that have not been mitigated or cancelled out by the presence of the interference filter 112 (the effects of which are shown by spectral transmittance curve STC in FIG. 9). The central absorber region 122 represents an area of greater transmittance of the green spectrum as allowed by the absorber layer 118, but that has otherwise been cancelled out or negated by the effects of the interference filter 112. In other words, any region with boosted transmittance in the green spectrum that overlaps the spectral distribution of the interference filter 112 will still be cancelled out by the reflective properties of the interference filter 112. It should be appreciated that the absorber layer 118 can be configured such that the average transmissivity of light within the first wavelength range FWR is less or equal to 70% while the average transmissivity of the second wavelength range SWR is greater than 70%.

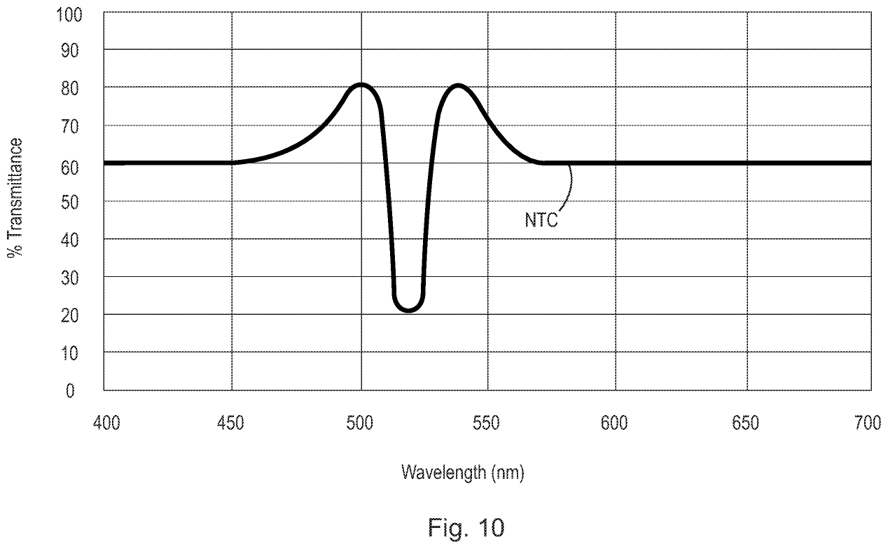

FIG. 10 shows one example of a net transmittance curve NTC of the two overlapping transmittance curves shown in FIG. 9. As shown, the net transmittance curve NTC is the product of the absorber transmittance curve ATC and the spectral transmittance curve STC of the interference filter 112 at any given wavelength. For example, at any given wavelength, the transmittance value of the absorber transmittance curve ATC multiplied by the transmittance of the spectral transmittance curve STC will give you a net transmittance value. Thus, the net transmittance curve NTC shown is the product of both the absorber transmittance curve ATC and the spectral transmittance curve STC at any given wavelength. It should be appreciated that the curve shown in FIG. 10 is an approximation and may not represent actual values of the net effect of both curves. In effect, the combination of these curves, as shown by net transmittance curve NTC, is that a substantial portion of the green light from the environment is reflected back to the environment, while relative transmittance of ranges of wavelengths of the visible spectrum immediately surrounding the wavelengths that are reflected by the interference filter 112, are boosted by the absorber layer 118. By boosting the relative transmittance of the wavelengths of light immediately surrounding those reflected by the interference filter 112, the user's eye will receive boosted transmittance of wavelengths/colors immediately surrounding and potentially including some wavelengths bordering the green spectrum. Although the narrow bandwidth of the reflected portion of light reflected by the interference filter 112 will still prevent green light of that narrow bandwidth from reaching the user's eye, the boosted absorption of the surrounding wavelengths operates to convince the user's mind into believing they are seeing wavelengths from the green spectrum and may operate to form images in the user's mind that contain the user's approximation of the color green. Thus, by overlapping an absorbing layer 118 and the interference filter 112, where the absorber layer 118 has a wider bandwidth than the interference filter 112, the image light guide system 100 can convince the user's mind into seeing green spectrum colors within real-world images even when a substantial portion of that spectrum is being blocked.

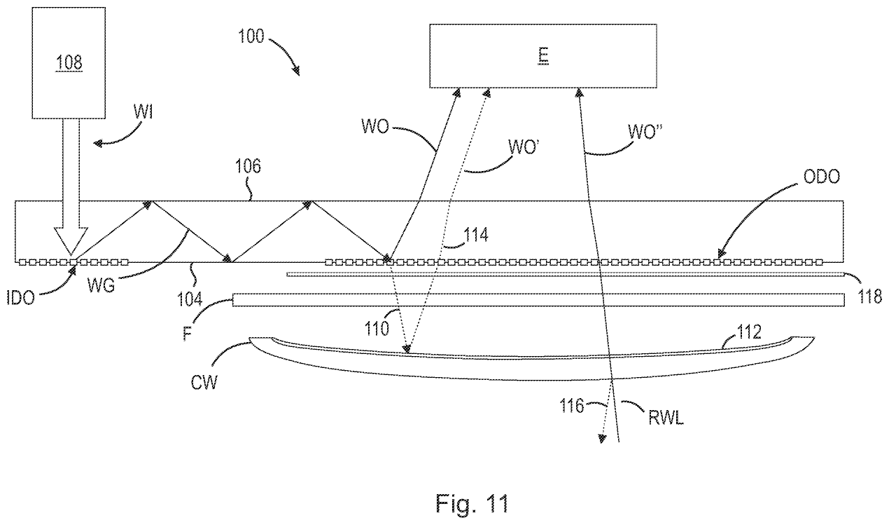

As illustrated in FIG. 11, in another operational example of the image light guide system 100, the image light guide 102 includes an in-coupling diffractive optic IDO and an out-coupling diffractive optic ODO that are both positioned on or within the front surface 104 of the image light guide 102 and are of a reflective-type diffractive optic. Thus, at least a portion of the image-bearing light WI generated by image source 108 is coupled into image light guide 102 after reflecting off one or more diffractive features of the in-coupling diffractive optic IDO. The coupled, and angularly encoded, image-bearing light WG propagates within image light guide 102 via TIR until it reaches one or more diffractive features of the out-coupling diffractive optic ODO, where it is reflected or diffracted out of image light guide 102 toward eyebox E. Although not illustrated, it should be appreciated that an anti-reflective (AR) coating can be provided on back surface 106 (as front surface 104 includes the optical diffractive features of in-coupling diffractive optic IDO and out-coupling diffractive optic ODO).

Although not shown, angularly encoded image-bearing light WG may have multiple interactions with the diffractive features of the out-coupling diffractive optic ODO, which operate to expand the size of the eyebox E in at least one dimension or direction. Each encounter along the length of the out-coupling diffractive optic ODO diffracts a portion of the angularly encoded image-bearing light WG out of the image light guide 102 as angularly decoded image-bearing light beams WO. However, another portion of the angularly encoded image-bearing light WG, i.e., first reflected portion 110, is reflected or diffracted from the periodic structures that comprise the out-coupling diffractive optic ODO and are emitted out of the front surface 104 toward the environment as potentially leaked light.

In the operational example shown, the image light guide system 100 also includes an interference filter 112 positioned on or embedded within the inner surface of the cover window CW (i.e., the surface closest to image light guide 102 when assembled). As discussed above, the interference filter 112 can, for example, be configured to reflect a narrow bandwidth of light of the green portion of the visible spectrum centered between 515 nm to 525 nm. As such, the first reflected portion 110 (being made of substantially green light), is reflected toward the image light guide 102 and passes through to eyebox E to increase the overall coupling efficiency of green virtual images as discussed above. However, real-world light RWL reflected off real-world objects in the environment, which would otherwise pass through image light guide 102 and enter the user's eye to form real-world images, will need to pass through interference filter 112. As such, sub-portion 116 of real-world light RWL that corresponds to the bandwidth of light reflected by interference filter 112 will be reflected to the environment, and real-world image-bearing light WO″ will contain significantly less light having wavelengths in the green spectrum. This would potentially cause real-world images formed in the user's eye by image-bearing light WO″ to appear pink/magenta as those images will be dominated by the other primary colors, i.e., red and blue, in the absence of green light.

To alleviate the pink/magenta effect caused by the interference filter 112, image light guide system 100 also includes an absorber layer 118 positioned between the cover window CW and the image light guide 102. It should also be appreciated that the absorber layer 118 could be positioned between front surface 106 and eyebox E, or on the outer surface of cover window CW, i.e., the surface opposite to the inner surface discussed above. As shown in FIGS. 9 and 10, by at least partially overlapping the interference filter 112 and the absorber layer 118, the net transmittance curve NTC, which represents the spectral composition of real-world light RWL that reaches the user's eyes, the user's mind will be influenced into seeing green light, or at least the user's approximation of green light, while also increasing the system efficiency and brightness of the virtual images. Thus, one advantage of the operational examples set forth by the present disclosure is the increased brightness of virtual images of a single waveband or bandwidth of light, while maintaining the user's normal perception of color within real-world images.

It should also be appreciated that in the foregoing operational example, by positioning the interference filter 112 at the inner surface of cover window CW, an additional calibration and/or alignment step may be needed as the reflected images formed by decoded image-bearing light WO′ may not align with the images formed by image-bearing light WO.

The perspective view shown in FIG. 12 illustrates one example of image light guide system 100 in a display system for augmented reality viewing of virtual images. The image light guide system 100 uses one or more image light guides (e.g., image light guides 102). Image light guide system 100 is shown as a head-mounted display (HMD) with a right-eye optical system 126R having an image light guide 102R proximate the user's right eye. The image light guide system 100 includes image source 108, such as a pico-projector or similar device, energizable to generate one or more virtual images. Although not illustrated, in one example, image light guide system 100 includes a left-eye optical system including one or more image light guides and a second image source. In examples using a right-eye optical system 126R and a left eye-optical system (not shown), the virtual images that are generated can be a stereoscopic pair of images for 3D viewing. During operation by a user, the virtual image or images formed by the image light guide system 100 can appear to be superimposed or overlaid onto the real-world scene content seen by the viewer through the right eye image light guide 102R and/or left eye image light guide. Additional components familiar to those skilled in the augmented reality visualization arts, such as one or more cameras mounted on the frame of the HMD for viewing scene content or viewer gaze tracking, can also be provided.

One or more features of the embodiments described herein may be combined to create additional embodiments which are not depicted. While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof. The embodiments described above are therefore to be considered in all respects as illustrative, and not restrictive. The scope of the invention is indicated by the appended claims, and all changes that come within the meaning and range of equivalents thereof are intended to be embraced therein.

What is claimed is:

1. An image light guide system, comprising:
an image light guide having a first surface and a second surface opposite the first surface;
an in-coupling diffractive optic operable to couple image-bearing light beams into the image light guide;
an out-coupling diffractive optic operable to direct at least a first portion of the image-bearing light beams from the image light guide toward an eyebox and direct a second portion of the image-bearing light beams from the image light guide away from the eyebox; and
an interference filter configured to reflect at least a sub-portion of the second portion of the image-bearing light beams and direct the sub-portion of the second portion of the image-bearing light beams towards the eyebox.

2. The image light guide system of claim 1, wherein the sub-portion of the second portion of the image-bearing light beams corresponds to a range of wavelengths within a visible portion of the electromagnetic spectrum.

3. The image light guide system of claim 2, wherein the range of wavelengths is between 495 nm and 570 nm.

4. The image light guide system of claim 1, wherein the interference filter is arranged to receive and transmit real-world image-bearing light from an environment around the user and wherein the interference filter is configured to receive and reflect a sub-portion of the real-world image-bearing light toward the environment.

5. The image light guide system of claim 4, wherein the sub-portion of the real-world image-bearing light corresponds to a range of wavelengths within a visible portion of the electromagnetic spectrum.

6. The image light guide system of claim 5, wherein the range of wavelengths is between 495 and 570 nm.

7. The image light guide system of claim 6, further comprising an absorber layer, wherein the absorber layer has a first transmissivity less than 70% with respect to a first range of wavelengths of the real-world image-bearing light and a second transmissivity greater than 70% with respect to a second range of wavelengths of the real-world image-bearing light.

8. The image light guide system of claim 7, wherein the absorber layer is disposed between the image light guide and the eyebox.

9. The image light guide system of claim 7, wherein the absorber layer is embedded within or engaged with a cover window.

10. The image light guide system of claim 7, wherein the absorber layer is located between the interference filter and a cover window arranged between the first surface and an environment.

11. The image light guide system of claim 7, wherein the absorber layer is thin-film gel film applied to the first surface of the image light guide.

12. The image light guide system of claim 7, wherein the absorber layer is a dye or pigment embedded into the image light guide or the cover window.

13. The image light guide system of claim 1, further comprising an image source configured to generate a plurality of angularly encoded image-bearing light beams.

14. The image light guide system of claim 1, wherein the first and second surfaces of the image light guide are plane-parallel surfaces.

15. The image light guide system of claim 1, wherein the interference filter has a transmissivity between 25%-50% with respect to the sub-portion of the second portion of the image-bearing light beams.

16. The image light guide system of claim 1, further comprising a cover window arranged between the first surface and an environment.

17. The image light guide system of claim 16, wherein the interference filter is embedded within or engaged with the cover window.
